(19) United States
(12) Patent Application Publication
(10) Pub. No.: US 2007/0168646 A1
(43) Pub. Date: Jul. 19, 2007

(54) Data exchange between cooperating processors

(76) Inventors: Jean-Francois Collard, Palo Alto, CA (US); Norman Paul Jouppi, Palo Alto, CA (US); Christophe Lemuet, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/333,708

(22) Filed: Jan. 17, 2006

(51) Int. Cl. G06F 15/00

(52) U.S. Cl. 712/34

(57) ABSTRACT

One embodiment relates to a computer apparatus including at least a microprocessor having an address space, an accelerator configured to cooperatively execute a program with the microprocessor, and a data register in the accelerator. The data register in the accelerator is mapped into the memory address space of the microprocessor. Other embodiments are also disclosed.

### BACKGROUND OF THE INVENTION

1. Field of the Invention

The present invention relates generally to computer systems.

2. Description of the Background Art

The functionality of a microprocessor may be extended or enhanced through the use of one or more cooperating processor or co-processor. Co-processors are typically specialized processors that operate at the direction of a main processor. One traditional use of a co-processor is as a math co-processor to provide floating point capabilities to microprocessor architectures that did not directly support such capabilities. Other uses of co-processors include digital signal processors, image processors, vector processors, and so on. Co-processors are sometimes referred to as accelerators.

A conventional microprocessor system is depicted in FIG. 1. The system typically includes at least a microprocessor 102, an input/output (I/O) interface 106, and memory 104. The memory 104 typically includes multiple dynamic random access memory (DRAM) units.

The microprocessor 102 typically includes various internal units. As depicted in FIG. 1, these units may include a point-to-point interface, a data cache (D Cache), a translation lookaside buffer (TLB), an instruction cache (I Cache), an instruction translation lookaside buffer (I-TLB), fetch & control circuitry, a load & store unit (LS), register files (shown as registers r0 through r31 and f0 through f31), and various other circuitry.

The microprocessor 102 is shown as inter-connecting to the rest of the system through multiple point-to-point links (via the point-to-point interface). However, other interconnect interfaces, such as buses, may be used in other implementations.

A conventional system including a microprocessor 202 and a co-processor 208 is depicted in FIG. 2. The two processors (202 and 208) may be configured nearly identically to each other (as shown in FIG. 2), or they may also be configured differently from each other. The system may include an input/output (I/O) interface 206 which is shared by the two processors (202 and 208), memory 204 for the main processor 202, and memory 210 for the co-processor 208.

Similar to FIG. 1, FIG. 2 shows the processors (202 and 208) as inter-connecting to the rest of the system through multiple point-to-point links (via the point-to-point interface). However, other interconnect interfaces, such as buses, may be used in other implementations.

Current systems provide communications between accelerators (co-processors) and the main processor either through a tight connection between the two processors or via I/O interfaces. Providing a tight connection between processors requires special attention when designing the main processor. In particular, a substantial amount of information about the operation of the accelerator is typically needed before designing certain circuitry within the main processor. Communicating through I/O interfaces, such as those of the PCI family, is disadvantageous due to the relatively high latencies and low bandwidths of the interfaces.

It is highly desirable to improve microprocessor systems. In particular, it is highly desirable to improve data exchange between cooperating processors.

### SUMMARY

One embodiment relates to a computer apparatus including at least a microprocessor having an address space, an accelerator configured to cooperatively execute a program with the microprocessor, and data registers in the accelerator. One or more data registers in the accelerator are mapped into the memory address space of the microprocessor.

Another embodiment relates to a method of data exchange between processors cooperatively executing a program. A data register in a first cooperative processor is mapped to an associated range in an address space of a second cooperative processor. Executing a command by the second cooperative processor to write data into the associated range causes the data to be written into the data register in the first cooperative processor.

Other embodiments are also disclosed.

### BRIEF DESCRIPTION OF THE DRAWINGS

FIG. 1 is a schematic diagram depicting a conventional microprocessor system.

FIG. 2 is a schematic diagram depicting a conventional system including a microprocessor and a co-processor.

FIG. 3 is a schematic diagram depicting a system including a microprocessor and a co-processor with memory-mapped register files in accordance with an embodiment of the invention.

FIG. 4 is a schematic diagram depicting a system including a microprocessor and a vector accelerator with memory-mapped register files in accordance with an embodiment of the invention.

### DETAILED DESCRIPTION

The present disclosure provides a mechanism by which a microprocessor may advantageously communicate with a co-processor or accelerator. This mechanism is distinct and different from conventional techniques which provide communications between the accelerator and the main processor either through a tight connection between the two processors or via I/O interfaces.

In accordance with an embodiment of the invention, the set of registers (also known as the register file) of the accelerator is memory-mapped into the space of addresses that the main processor is capable of writing data to and reading data from. This enables to main processor to communicate using standard load and store instructions with the accelerator to provide the accelerator with the data it needs to operate upon. Advantageously, the data is communicated directly into the level of memory that is manipulated by the accelerator, i.e. into the data registers of the accelerator.

Memory mapping has been conventionally used to facilitate the transfer of data from a main CPU to an input/output device. (For example, mapping an address range to screen pixels such that storing a value at an address changes an intensity of a pixel on a monitor.) However, such an input/output device does not participate in the execution of a program by the main CPU. The present application discloses the use of memory-mapped registers to exchange data between multiple programmable processors collaborating in parallel to execute a program.

Previous memory-mapped registers in cooperating processors are generally restricted to communicating descriptions of actions to be taken (commands or status registers). However, the memory-mapped registers disclosed herein contain data to be operated upon.

Communicating data to be operated upon between cooperating processors via memory-mapped register files advantageously provides for rapid inter-processor communication without needing to modify the accelerated (i.e. the main) processor. In other words, while the design of the accelerator is modified to accommodate this technique, the main microprocessor may be unmodified and off-the-shelf, saving cost and effort.

In addition, utilizing memory-mapped register files as disclosed herein enable rapid data synchronizations between the main processor and the accelerator. The main processor may be configured or programmed by software to store an agreed-upon value directly into one of the accelerator's registers to indicate an event. The accelerator may be configured to poll that register to be notified of the event without needing to send requests to its cache or external memory.

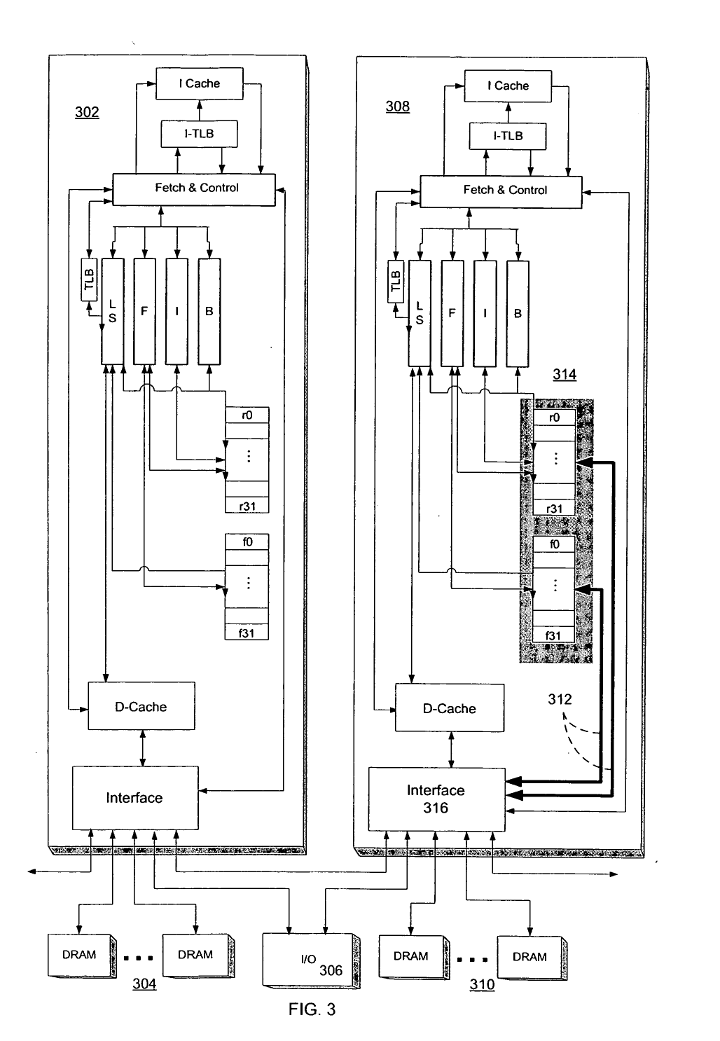

Scalar Accelerator FIG. 3 is a schematic diagram depicting a system including a microprocessor 302 and a co-processor 304 with memory-mapped register files in accordance with an embodiment of the invention. The two processors (302 and 308) may be configured nearly identically to each other (as shown in FIG. 3), or they may also be configured differently from each other. The system may include an input/output (I/O) interface 306 which is shared by the two processors (302 and 308), memory 304 for the main processor 302, and memory 310 for the co-processor 308.

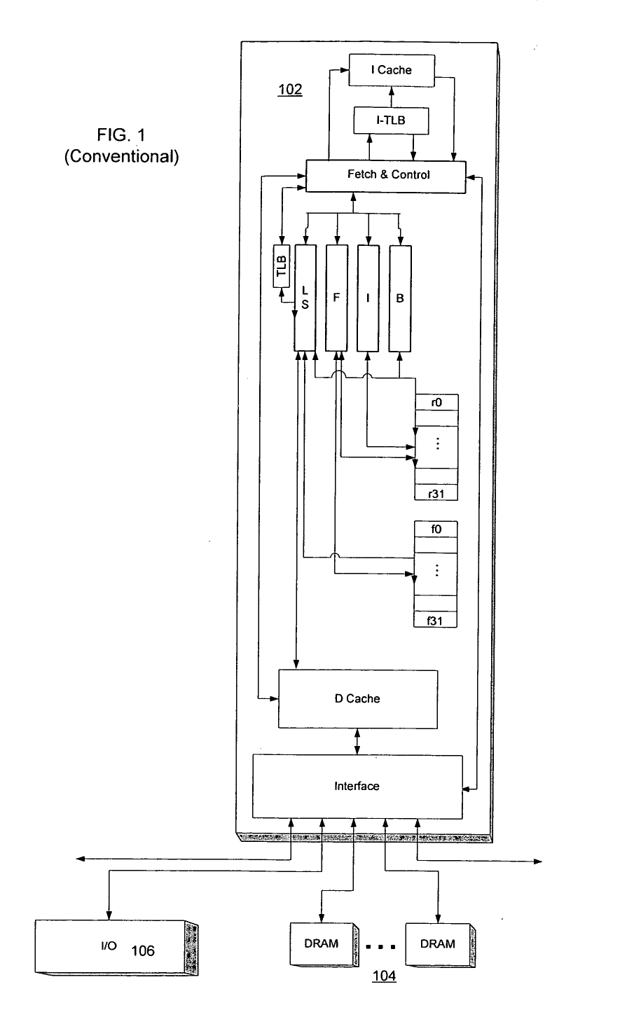

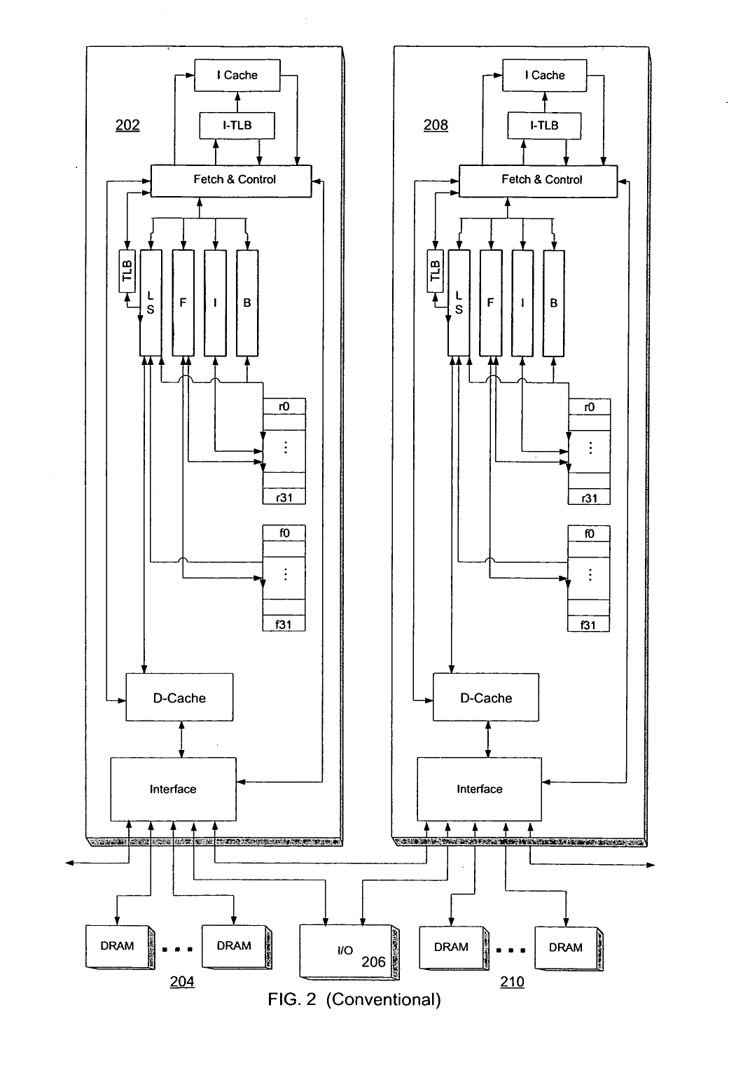

Similar to FIGS. 1 and 2, FIG. 3 shows the processors (302 and 308) as inter-connecting to the rest of the system through multiple point-to-point links (via the point-to-point interface). However, other interconnect interfaces, such as buses, may be used in accordance with other embodiments.

In accordance with an embodiment of the invention, additional communication lines 312 are added between the register files 314 and the interface 316 on the accelerator 308. These communication lines 312 bypass the data cache and the fetch and control circuitry of the accelerator 308. Furthermore, the interface 316 is configured to allow for direct connection to the register files 314 from other components of the system, including the main processor 302. Hence, when the main processor 302 needs to provide data to the accelerator 308, the processor 302 may simply write the data into the agreed-upon register in the register file 314 of the accelerator 308.

By mapping the register file 314 of the accelerator 308 into the memory space of the main processor, the main processor may, for example, store the value 1 at memory address 8000 in order to set register r0 to value 1 on the accelerator 308. In other words, writing data to the registers 314 on the co-processor 308 is performed by the main processor 302 as if the main processor was storing the data into a specific address in memory. However, this address is special in the sense that it may not in fact correspond to actual physical memory 304, and accesses to this address are redirected to the appropriate register 314 on the co-processor 308. A range of addresses in memory space of the main processor 302 are mapped to the register files 314 on the co-processor 308. In one embodiment, these addresses may be backed up by actual memory storage 304. Alternatively, these mapped addresses may have no actual memory storage 304 backing up the values stored in the co-processor's registers 314.

Vector Accelerator

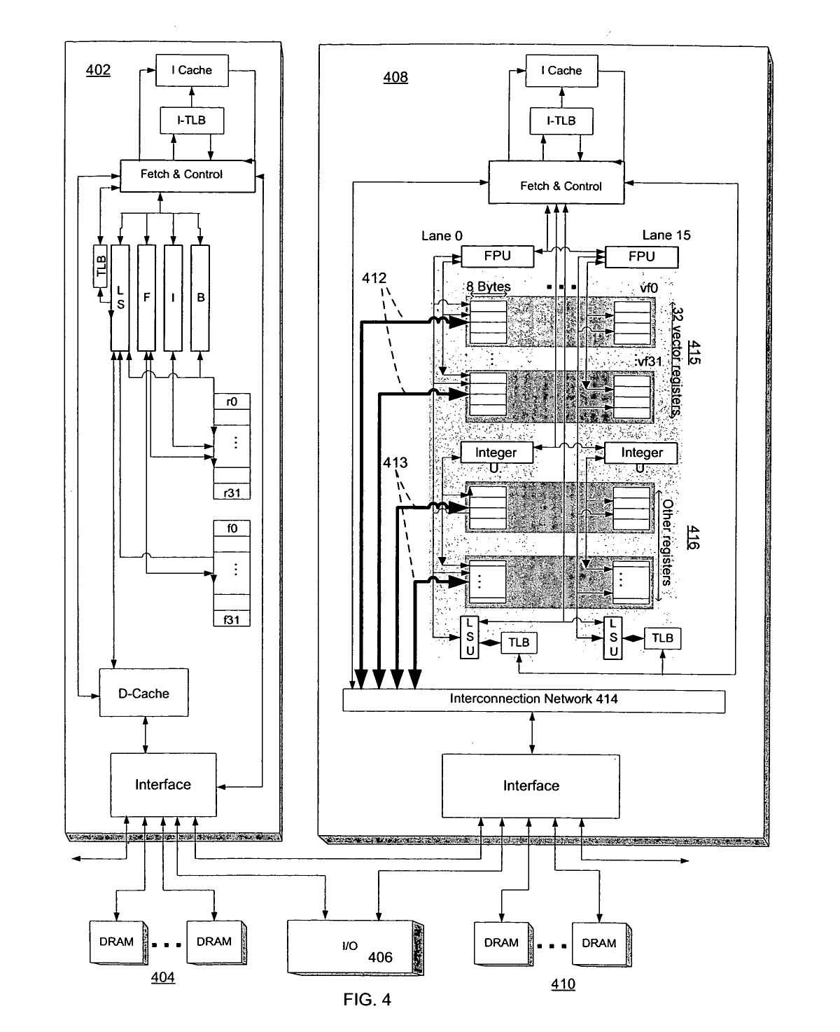

FIG. 4 is a schematic diagram depicting a system including a microprocessor 402 and a vector accelerator 408 with memory-mapped register files in accordance with an embodiment of the invention. The system may include an input/output (I/O) interface 404 which is shared by the two processors (402 and 408), memory 406 for the main processor 402, and memory 410 for the vector accelerator 408.

The vector accelerator 408 may be configured with multiple functional units. These functional units may be referred to as “lanes”. In the example depicted in FIG. 4, the vector accelerator has sixteen lanes (lane 0 through lane 15). The lanes process data in parallel and utilize their own portion of the accelerator's registers.

In one embodiment, the accelerator's registers comprise vector registers. While each lane typically holds its own element or elements of the vector register, the main processor 402 may still be configured to access the entire vector at a time. Storing a new value into an accelerator's vector register may be performed by the main processor 402 via one or multiple stores to a range of the memory address space.

For example, consider a vector accelerator with 16 lanes. Further, consider a vector register designated by the name “v12” which has 16 elements that are each 8 bytes long, and that v12 is mapped by the main processor 402 starting at memory address 9000. Storing a 1 at address 9000 will set the first element of v12 (the element processed by the first lane) to 1. Storing a 1 at address 9008 (the start address plus an offset equal to the size of the first element) will set the second element of v12 (the element processed by the second lane) to 1. Storing a 1 at address 9016 (the start address plus an offset equal to the size of the first and second elements) will set the third element of v12 (the element processed by the third lane) to 1. And so on.

Similar to FIGS. 1, 2 and 3, FIG. 4 shows the processors (402 and 408) as inter-connecting to the rest of the system through multiple point-to-point links (via the point-to-point interface). However, other interconnect interfaces, such as buses, may be used in accordance with other embodiments.

In accordance with an embodiment of the invention, additional communication lines 412 and 413 are added between an interconnection network (e.g., a crossbar switch) 414 and the registers (vector registers 415 and other registers 416, respectively) on the vector accelerator 408. These communication lines 412 and 413 bypass the fetch and control circuitry of the accelerator 408. Furthermore, the interconnection network 414 is configured to control the direct connections to the registers. Hence, when the main processor 402 needs to provide data to the vector accelerator 408, the main processor 402 may simply write the data into the agreed-upon register of the accelerator 408.

Note that the above-disclosed use of a memory-mapped register in a vector accelerator is distinct over known earlier work in vector computers and vector accelerators. For example, in a prior vector computer (the FPS T Series computer from Floating Point Systems, formerly of Beaverton, Oreg.) included multiple nodes, where each node includes a control processor, a vector processor, vector registers, and local memory banks. Each register is connected to one memory bank. In the FPS T Series computer, the control processor has direct access to the memory banks of the node and controls the transfer of data between a bank and its associated vector register. However, the control processor appears to have no direct access to the vector register. In particular, the vector register is not mapped to the address space of the control register.

Note that a memory-mapped register file as disclosed herein is quite different from a coherent memory or cache. In a coherent memory or cache, any modification of a value in one part of the system is automatically propagated to all other parts, possibly involving the invalidation or updating of copies of the data. A memory-mapped register does not necessarily involve such automatic propagation.

Note that the systems described above in relation to FIGS. 3 and 4 may each be configured such that the main microprocessor (302 or 402) also includes one or more memory-mapped register. In such a system, the memory-mapped register in the main microprocessor (302 or 402) would be mapped into the address space of the accelerator (308 or 408, respectively). The accelerator may then write data to or read data from the memory-mapped register in the main microprocessor by its standard store or load instructions.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. A computer apparatus comprising:
a microprocessor having an address space;
an accelerator configured to cooperatively execute a program with the microprocessor; and
a data register in the accelerator,
wherein the data register in the accelerator is mapped into the address space of the microprocessor.

2. The apparatus of claim 1, wherein the data register is writable and readable by the microprocessor using standard read and write instructions.

3. The apparatus of claim 1, further comprising:
communication lines between interface circuitry and data registers in the accelerator through which the data registers are directly writable.

4. The apparatus of claim 3, wherein said communication lines bypass fetch circuitry of the accelerator.

5. The apparatus of claim 3, wherein the interface circuitry comprises a point-to-point interface coupling the accelerator to other components of the computer apparatus.

6. The apparatus of claim 3, wherein the interface circuitry comprises an interface to a bus coupling the accelerator to other components of the computer apparatus.

7. The apparatus of claim 1, wherein the accelerator comprises a vector accelerator.

8. The apparatus of claim 7, further comprising:
communication lines to data registers in the vector accelerator which bypass fetch circuitry of the vector accelerator.

9. The apparatus of claim 8, wherein the data registers are writable and readable by the microprocessor using standard read and write instructions.

10. A method of data exchange between processors cooperatively executing a program, the method comprising mapping a data register in a first cooperative processor to an associated range in an address space of a second cooperative processor, wherein executing a command by the second cooperative processor to write data into the associated range causes the data to be written into the data register in the first cooperative processor.

11. The method of claim 10, wherein the data is written directly into said data register using communication lines in the first cooperative processor which bypass fetch circuitry of the first cooperative processor.

12. The method of claim 10, wherein the first cooperative processor comprises a vector accelerator.

13. The method of claim 12, wherein the data is written directly into said data register using communication lines which bypass fetch circuitry of the first cooperative processor.

14. The method of claim 10, wherein said data register is writable and readable by the second cooperative processor using standard write and read instructions.

15. A computer system including at least two cooperative processors, the system comprising a first cooperative processor which includes a data register which is mapped to an associated range in an address space of a second cooperative processor, wherein executing a command by the second cooperative processor to write data into the associated range causes the data to be written into the data register in the first cooperative processor.

16. The system of claim 15, wherein the data is written into the data register using communication lines which bypass fetch circuitry of the first cooperative processor.

17. The system of claim 15, wherein the first cooperative processor comprises a vector accelerator.

18. The system of claim 17, wherein the data is written into the data register using communication lines which bypass fetch circuitry of the vector accelerator.

19. The system of claim 15, wherein the data register is writable and readable by the second cooperative processor using standard store and load instructions.

20. The system of claim 15, wherein the second cooperative processor includes a second data register which is mapped to an associated range in an address space of the first cooperative processor, wherein executing a command by the first cooperative processor to write data in the associated range in the address space of the first cooperative processor causes the data to be written into said second data register in the second cooperative processor.
